(19) United States
(12) Patent Application Publication
(10) Pub. No.: US 2022/0400668 A1
(43) Pub. Date: Dec. 22, 2022

(54) MICROEMULSION COMPOSITIONS OF TOPRAMEZONE

(71) Applicant: BASF SE, Ludwigshafen am Rhein (DE)

(72) Inventors: Shawn Dickess, Cincinnati, OH (US); Dean A. Oester, Cincinnati, OH (US)

(21) Appl. No.: 17/413,910

(22) PCT Filed: Sep. 19, 2019
(86) PCT No.: PCT/EP2019/075167

§ 371 Date: Jun. 14, 2021

Related U.S. Application Data
(60) Provisional application No. 62/740,494, filed on Oct. 3, 2018.

(30) Foreign Application Priority Data
Oct. 29, 2018 (EP) 18203067.6

(51) Int. Cl. A01N 25/04; A01N 35/02; A01N 43/56; A01N 43/80

(52) U.S. Cl. CPC A01N 25/04; A01N 35/02; A01N 43/56; A01N 43/80

(57) ABSTRACT

Described herein are microemulsion compositions including topramezone and, in particular, microemulsion compositions of topramezone that are amenable as a ready to use solution or in the form of a spray. Also described herein is the use of these compositions for controlling undesirable vegetation, in crops and non-crops.

### FIELD OF THE INVENTION

The presently claimed invention relates to herbicidal microemulsion compositions comprising topramezone. The presently claimed invention also relates to the use of these microemulsion compositions for controlling undesirable vegetation in crops and non-crops. Non-crop areas include tufts, lawns, golf courses or parks.

### BACKGROUND OF THE INVENTION

In crop protection, it is desirable in principle to increase the specificity and the reliability of the action of active compounds. Particularly, it is desirable for the crop protection products to control the growth of the harmful plants (weeds) effectively and, at the same time, to be tolerated by the useful plants in question.

Herbicides find widespread use in commercial agriculture and have enabled an increase in crop yields and product quality. They are routinely used to control various weeds, for example, grasses and broadleaved weeds such as Amaranthus, foxtails and others, whenever these weeds pose risks to crop yield.

Topramezone (4-[3-(4,5-dihydro-1,2-oxazol-3-yl)-2-methyl-4-methyl sulfonyl benzoyl]-2-methyl-1H-pyrazol-3-one) and agriculturally acceptable salts, are well known herbicidally active compounds [C. D. S Tomlin (Ed.), The Pesticide Manual, 14th ed., 2006, BCPC Alton, Hampshire, UK, p. 1047]. Topramezone and a general procedure for its preparation are disclosed in the patent applications, WO 98/31681 and WO 99/58509.

Topramezone is an inhibitor of 4-hydroxyphenylpyruvat-dioxygenase (4-HPPD inhibitor) and controls the growth of annual warm season grasses such as Echinochloa, Setaria Digitaria and Panicum species, and of dicotyledonous weeds, like Chenopodium, Atriplex, Amaranthus, Solanum, Galinsoga, Stellaria media, Lamium, and Veronica-species. The herbicidal activity and the activity spectrum, however, are sometimes limited. Commercially formulation of topramezone are recommended to be applied in combination with adjuvants such as Dash® to achieve a reliable herbicidal action. Formulations of topramezone are marketed by BASF SE under the tradenames Clio® and Clio® super (co-formulation of topramezone with dimethenamid-P).

Topramezone is often formulated as a water dispersible granule (WG) or as a suspension concentrate (SC), i.e., a solid suspension. In such formulations, the active ingredients may be milled to a particular size and the solid subsequently suspended in an aqueous-based carrier vehicle. The WG formulation is typically made with inert compounds that have little adjuvancy, and it can be difficult to make the active ingredient bioavailable to control weeds. The particulate size of the active ingredient in these formulations, and during application, often remains too large such that a substantial amount of the formulation must be applied per acre to control weeds. Similarly, a suspension concentrate formulation has the disadvantage that adjuvants are hard to incorporate at a useful rate, and they provide little impetus for foliar uptake and biotranslocation, and thus a substantial amount of the formulation must be applied per acre to control weed infestations.

Thus, it is desirable to formulate topramezone as a microemulsion to overcome the above stated limitations.

Microemulsions are multiphase systems comprising a dispersed phase and a continuous phase. In contrast to macroemulsions, the average particle (droplets) size (Z=average diameter as determined by light scattering) of the dispersed phase in microemulsions is at least 5 times smaller than in macroemulsions and generally does not exceed 200 nm, while the average diameter of the droplets in macroemulsions is in μm range. Microemulsions are known as bicontinuous structures with intricate channels of oily and aqueous phases. Due to the small particle size (droplet size) of the dispersed phase, or the intricate channels, microemulsions have a translucent appearance.

Microemulsion formulation of herbicide compounds are usually water based and additionally contain at least one surfactant and at least one co-solvent or cosurfactant. By using microemulsion, formulation risks such as inflammability and toxicity, environmental concerns and costs are reduced in comparison to emulsifiable concentrate (EC) techniques, because water is the main constituent. Due to the small particle size of the dispersed phase containing the active ingredient, an increase in bioavailability can often be achieved. However, it is difficult to maintain the stability of a microemulsion formulation of active ingredients having a low water-solubility with respect to the droplet size, uniformity and crystallization of the active ingredient. Moreover, it is also difficult to maintain the droplet size stability when the microemulsion formulation is diluted with water. However, a stable droplet size after dilution, i.e. maintaining a small droplet size, is important to achieve preferable biological activities. Therefore, much effort has been made to develop stable water-based microemulsion formulation.

Therefore, it is an object of the presently claimed invention to provide a stable microemulsion formulation of topramezone which would be readily amenable for use and is readily bioavailable.

### SUMMARY OF THE INVENTION

It has been surprisingly found that topramezone can be formulated as a stable microemulsion.

Thus, in one aspect, the presently claimed invention relates to microemulsion compositions comprising 0.1 wt. % to 1.0 wt. % of topramezone

In yet another aspect the composition has a pH of 6.1-7.4, when measured at 25° C.

In another aspect, the presently claimed invention relates to microemulsion compositions comprising solvents, emulsifier-surfactants, stabilizers and pH-adjusting agents.

In yet another aspect, the presently claimed invention relates to a microemulsion compositions comprising 10 wt. % to 40 wt. % of a first solvent which is from the group of aromatic alcohols, ethers, alkyl lactates, alkyl esters of fatty acids and mixtures thereof and a second solvent which is from the group of aromatic alcohols, ethers, alkyl lactates, alkyl esters of fatty acids and mixtures thereof, whereby the second solvent is different from the first solvent.

In a further aspect of the presently claimed invention, the first solvent has Hansen solubility parameters in the ranges of δ d 8-12 cal^{1/2} cm^{-3/2}, δp 2-4 cal^{1/2} cm^{-3/2} and δ h5-8 cal^{1/2} cm^{-3/2} and the second solvent has Hansen solubility parameters in the ranges of δ d 6-8 cal^{1/2} cm^{-3/2,} δ p1-3 cal^{1/2} cm^{-3/2}, and δ h1-3 cal^{1/2} cm^{-3/2}.

In a further aspect of the presently claimed invention, the first emulsifier-surfactant is a non-ionic surfactant which is present in a range of 10 wt. % to 40.0 wt. %, based on the total weight of the microemulsion composition, and second emulsifier-surfactant is a non-ionic surfactant which is present in a range of 10 wt. % to 40.0 wt. %, based on the total weight of the microemulsion composition.

In another preferred embodiment of the presently claimed invention, the non-ionic surfactant is selected from alkyl polyglycoside, glycerol esters of fatty acids, alkoxylated alcohol, alkoxylated natural oil, glycerol esters, alkoxylated reduced sugar esters, alkoxylated glycerol monococoate, esters of polyhydric alcohol, alkoxylated amines, alkoxylated esters, alkoxylated alkyl or arylphenols and ethylene oxide/propylene oxide copolymer and mixtures thereof.

In a further aspect of the presently claimed invention, the stabilizer is a base which is from the group of triethanolamine and cationic polyethyleneimine polymer.

In yet another aspect of the presently claimed invention, the cationic polyethyleneimine polymer has a molecular weight of 500 g/mol to 1000 g/mol.

In an aspect of the presently claimed invention, the pH-adjusting agent is selected from citric acid, sulfuric acid, acetic acid, maleic acid, potassium phosphate, oleic acid, and mixtures thereof.

In an aspect, the presently claimed invention relates to a method of controlling the undesired vegetation by applying the microemulsion compositions comprising topramezone in a range of 0.1 wt. % to 1.0 wt. % as a ready to use formulation or as a spray.

In yet another aspect, the presently claimed invention relates to the use of the microemulsion compositions comprising topramezone in a range of 0.1 wt. % to 1.0 wt. % for controlling the undesired vegetation.

The microemulsion compositions of the presently claimed invention provide stable composition of topramezone.

The microemulsion compositions of the presently claimed invention are stable on dilution.

The microemulsion compositions of the presently claimed invention are stable liquid compositions that are clear and stable upon storage at 50° C. for at least 120 days.

### DETAILED DESCRIPTION OF THE INVENTION

Before the present compositions and formulations of the invention are described, it is to be understood that this invention is not limited to compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay 30 there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

The term “stable” as used herein refers to microemulsion compositions comprising topramezone, wherein the formulation remains unchanged, i.e. without any precipitation or turbidity or phase separation.

The presently claimed invention relates to microemulsion compositions comprising 0.1 wt. % to 1.0 wt. % of topramezone and the compositions having a pH of 6.1-7.4, when measured at 25° C.

Topramezone is a selective herbicide in the phenyl pyrazolyl ketone chemical family used for postemergence control mainly of broadleaf weeds as well as some grasses in field maize, sweet maize, and popcorn. It is represented by the following structure:

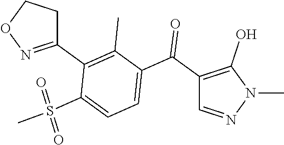 [SMILES: Cc1c(C(=O)c2cnn(C)c2O)ccc(S(C)(=O)=O)c1C1=NOCC1]

The solubility of topramezone in water about 0.305 g/L at 25° C. Further, the solubility of topramezone in various organic solvents is also limited.

It has been surprisingly found that topramezone can be formulated as a microemulsion, wherein the amount of topramezone is from 0.1 wt % to 1.0 wt %, based on the final weight of the composition, and the pH of the composition is from 6.5-7.4.

Microemulsions are multiphase systems comprising a dispersed phase and a continuous phase. In contrast to macroemulsions, the average particle (droplets) size (Z=average diameter as determined by light scattering) of the dispersed phase in microemulsions is at least 5 times smaller than in macroemulsions and generally does not exceed 200 nm, while the average diameter of the droplets in macroemulsions is in μm range. Microemulsions are known as bicontinuous structures with intricate channels of oily and aqueous phases. Due to the small particle size (droplet size) of the dispersed phase, or the intricate channels, microemulsions have a translucent appearance.

Microemulsion compositions of the presently claimed invention can be water-in-oil microemulsion or oil-in-water microemulsion depending on whether water is the dispersed phase and oil is the continuous phase or oil is the dispersed phase and water is the continuous phase.

In a preferred embodiment, the microemulsion of the presently claimed invention is an oil-in-water emulsion, i.e. water forms the continuous phase, while the solvent and topramezone are present in the dispersed phase.

In an embodiment, the amount of topramezone is in the range of 0.1 to 1.0% or 0.1 to 0.9% or 0.1 to 0.8% or 0.1 to 0.7% or 0.1 to 0.6% or 0.1 to 0.5% or 0.1 to 0.4% or 0.1 to 0.3% or 0.1 to 0.2% by weight, in each case based on the final weight of the composition.

The presently claimed invention relates to microemulsion compositions comprising solvents, emulsifier-surfactants, stabilizers and pH-adjusting agents.

In an embodiment of the presently claimed invention, the solvent is selected from the class of aromatic alcohols, ethers, alkyl lactates, alkyl esters of fatty acids and mixtures thereof.

In an embodiment, the presently claimed invention relates to a microemulsion composition comprising 10 wt. % to 40 wt. % of a first solvent and a second solvent, each selected from aromatic alcohols, ethers, alkyl lactates, alkyl esters of fatty acids and mixtures thereof.

In an embodiment of the presently claimed invention, representative examples of the aromatic alcohols are benzyl alcohol, phenylethanol, 1-phenoxy-2-propanol and 2-phenoxy-ethanol.

In a preferred embodiment, the aromatic alcohol is benzyl alcohol.

In another embodiment of the presently claimed invention, the representative examples of the ethers are ethylene glycol phenyl ether, dipropylene glycol methyl ether, ethylene glycol diethyl ether and dipropylene glycol n-propyl ether.

In yet another embodiment, representative examples of the alkyl lactates are ethyl lactate, propyl lactate and butyl lactate.

In another embodiment, representative examples of the alkyl esters of fatty acids are methyl ester of fatty acids ethyl esters of fatty acid and isopropyl ester of fatty acids, such as methyl oleate, methyl palmitate, methyl laurate, isopropyl myristate and isopropyl palmitate.

The ability of a solvent to dissolve a given substance, e.g. a triazole fungicide, may conveniently be evaluated by parameter consideration according to the “Hansen system”, which is described in “Hansen Solubility Parameters—A Users Handbook”, published by CRC Press (2000). According to the Hansen system, a solvent or mixture of solvents may be described by three solubility parameters δ d (dispersion parameter), δ p (polarity parameter) and δ h (hydrogen bonding parameter). Different solvents with regard to Hansen solubility parameters and molecular structures have been found to be particular useful as solvents.

In an embodiment of the presently claimed invention, the first solvent has Hansen solubility parameters in the ranges of δ d 8-12 cal^{1/2} cm^{-3/2}, δ p 2-4 cal^{1/2} cm^{-3/2} and δ h5-8 cal^{1/2} cm^{-3/2} and the second solvent has Hansen solubility parameters in the range of δ d 6-8 cal^{1/2} cm⁻3/2, δ p1-3 cal^{1/2} cm^{-3/2}, and δ h1-3 cal^{1/2} cm^{-3/2}.

In an embodiment of the presently claimed invention, the first solvent has Hansen solubility parameters in the ranges of 6d 8-10 cal^{1/2} cm^{-3/2}, δ p 2-3.5 cal^{1/2} cm^{-3/2} and δ h 5-7 cal^{1/2} cm^{-3/2}.

In a further embodiment of the presently claimed invention, the first solvent has Hansen solubility parameters in the ranges of δ d 8-10 cal^{1/2} cm^{-3/2}, δ p 2.5-3.5 cal^{1/2} cm^{-3/2} and δ h 6-7 cal^{1/2} cm^{-3/2}.

In an embodiment of the presently claimed invention, the first solvent has Hansen solubility parameters as δ d 9 cal^{1/2} cm^{-3/2}, δ p 3.1 cal^{1/2} cm^{-3/2} and δ h 6.7 cal^{1/2} cm^{-3/2}.

In an embodiment of the presently claimed invention, the first solvent is benzyl alcohol.

In an embodiment of the presently claimed invention, the second solvent has Hansen solubility parameters in the ranges of δ d 6.5-8 cal^{1/2} cm^{-3/2}, δ p 1.5-3 cal^{1/2} cm^{-3/2}, and δ h 1.5-3 cal^{1/2} cm^{-3/2}.

In a further embodiment of the presently claimed invention, the second solvent has Hansen solubility parameters in the ranges of δ d 6.5-7.5 cal^{1/2} cm^{-3/2}, δ p 1.5-2.5 cal^{1/2} cm^{-3/2}, and δ h 1.5-2.5 cal^{1/2} cm^{-3/2}.

In an embodiment of the presently claimed invention the second solvent has Hansen solubility parameters as δ d 7.1 cal^{1/2} cm^{-3/2}, δ p 1.9 cal^{1/2} cm^{-3/2}, and δ h 1.8 cal^{1/2} cm^{-3/2}.

In an embodiment of the presently claimed invention, the second solvent is methyl oleate.

In a preferred embodiment of the presently claimed invention, the amount of the first solvent is in the range of from 0.1 to 10% or 0.1 to 9% or 0.1 to 8% or 0.1 to 7% or 0.1 to 6% or 0.1 to 5% or 0.1 to 4% or 0.1 to 3% or 0.1 to 2% or 0.1 to 1%, more preferably in the range of 0.1 to 9.5% or 0.1 to 8.5% or 0.1 to 7.5% or 0.1 to 6.5% or 0.1 to 5.5%, in each case based on the final weight of the composition.

In a preferred embodiment of the presently claimed invention, the amount of the second solvent is in the range of from 1 to 25% or 1 to 22.5% or 1 to 20% or 1 to 17.5% or 1 to 15% or 1 to 12.5% or 1 to 10% or 1 to 7.5% or 1 to 5% or 1 to 2.5%, more preferably in the range of 5 to 25% or 5 to 22.5% or 5 to 20% or 5 to 17.5% or 10 to 25% or 10 to 22.5% or 10 to 20% or 10 to 17.5% or 15 to 25%, 15 to 22.5%, 15 to 20%, in each case based on the final weight of the composition.

In an embodiment of the presently claimed invention, the microemulsion compositions 25 comprises emulsifier-surfactants.

In an embodiment of the presently claimed invention, the microemulsion composition comprises a first emulsifier-surfactant and a second emulsifier-surfactant.

In an embodiment of the presently claimed invention, the first emulsifier-surfactant is a non-ionic surfactant present in a range of 10 wt. % to 40.0 wt. %, based on the total weight of the microemulsion composition, and the second emulsifier-surfactant is a non-ionic surfactant present in a range of 10 wt. % to 40.0 wt. %, based on the total weight of the microemulsion composition.

In an embodiment of the presently claimed invention, the non-ionic surfactant is selected from alkyl polyglycoside, glycerol esters of fatty acids, alkoxylated alcohol, alkoxylated natural oil, glycerol esters, alkoxylated reduced sugar esters, alkoxylated glycerol monococoate, esters of polyhydric alcohol, alkoxylated amines, alkoxylated esters, alkoxylated alkyl or arylphenols and ethylene oxide/propylene oxide copolymer and mixtures thereof.

In an embodiment of the presently claimed invention, the first emulsion-surfactant is glycerol esters of fatty acids.

The fatty acids are selected from oleic acid, stearic acid, isostearic acid, lauric acid, palmitic acid, myristic acid, linoleic acid, capric acid and caprylic acid, and mixtures thereof.

Exemplary glycerol esters of fatty acids are glyceryl oleate commercially available as Monomuls® 90-O 18 and glyceryl laurate commercially available as Monomuls® 90-L 12 from BASF.

In a preferred embodiment of the presently claimed invention, the amount of the first emulsifier-surfactant is in the range of from 1 to 10% or 1 to 9% or 1 to 8% or 1 to 7% or 1 to 6% or 1 to 5% or 1 to 4% or to 3% or 1 to 2%, more preferably in the range of 2 to 6% or 2 to 5% or 2 to 4% by weight, in each case based on the final weight of the composition.

In an embodiment of the presently claimed invention, the second non-ionic surfactant is an alkyl polyglycoside represented by the formula (I)

R₁O(R₂O)_{b}(Z)ₐ (I)

wherein:
R₁ is linear or branched, unsubstituted or substituted C₄-C₃₀ alkyl or linear or branched, unsubstituted or substituted C₄-C₃₀ alkenyl;
R₂ is linear or branched, unsubstituted or substituted C₂-C₄ alkylene;
b is 0 to 100
Z is a saccharide residue having 5 to 6 carbon atoms; and
a is an integer from 1 to 6.

In a more preferred embodiment the alkyl polyglycoside represented by the formula (I) has the following substitution
R₁ is straight chain or branched chain, unsubstituted or substituted C₄-C₂₂ alkyl straight chain or branched chain, unsubstituted or substituted C₄-C₂ alkenyl,
R₂ is straight chain C₂-C₄ alkylene
b is 0 to 12
Z is a saccharide residue having 5 to 6 carbon atoms. Z may be glucose, mannose, fructose, galactose, talose, gulose, altrose, allose, apiose, gallose, idose, ribose, arabinose, xylose, lyxose, or a mixture thereof; and
a is an integer from 1 to 3.

In an embodiment the alkyl polyglycoside represented by the formula (I) has the following substitution
R₁ is linear or branched, unsubstituted C₈-C₁₆ alkyl;
b is 0;
Z is glucose; and
a is an integer from 1 to 2.

Typical compounds of formula (I) are compounds of formula (Ia):

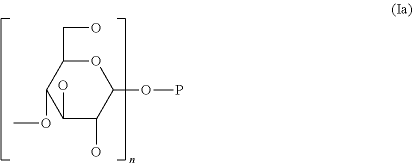

where n is the degree of polymerization and is from 1 to 3, preferably 1 or 2, and P is a branched or straight chain alkyl group having from 4 to 18 carbon atoms or a mixture of alkyl groups having from 4 to 18 carbon atoms. Typically, the alkyl polyglucoside (APG) comprises an alkyl group containing 8- to 10 carbon atoms and has an average degree of polymerization of 1.7; an alkyl group containing 9 to 11 carbon atoms and has an average degree of polymerization of 1.3 to 1.6; or a mixture thereof.

Exemplary alkyl polyglycosides include APG® 325 (BASF) (an alkyl polyglycoside in which the alkyl group contains 9 to 11 carbon atoms and has an average degree of polymerization of 1.6), PLANTAREN® 2000 (BASF) (an alkyl polyglycoside in which the alkyl group contains 8 to 16 carbon atoms and has an average degree of polymerization of 1.4), PLANTAREN® 1300 (BASF) (an alkyl polyglycoside in which the alkyl group contains 12 to 16 carbon atoms and has an average degree of polymerization of 1.6), AGNIQUE® PG 8107 (BASF) (an alkyl polyglycoside in which the alkyl group contains 8 to 10 carbon atoms and has an average degree of polymerization of 1.7), AGNIQUE® PG 9116 (BASF) (an alkyl polyglycoside in which the alkyl group contains 9 to 11 carbon atoms and has an average degree of polymerization of 1.6) and AGNIQUE® PG 8105 (BASF) (an alkyl polyglycoside in which the alkyl group contains 8 to 10 carbon atoms and has an average degree of polymerization of 1.5).

In an embodiment, the alkyl polyglycoside is a C₈-C₁₀ alkyl polyglucoside.

In an embodiment of the presently claimed invention, the second emulsifier—surfactant is present in an amount in the range of 5 to 40% or 5 to 35% or 5 to 30% or 5 to 25% or 5 to 20% or 5 to 10% or 10 to 40% or 10 to 35% or 10 to 30% or 10 to 25% or 10 to 20% more preferably in the range of 15 to 30% or 15 to 25% or 20 to 30% or 20 to 25% or 25 to 30%, in each case based on the final weight of the composition.

In a further aspect of the presently claimed invention, the stabilizer is a base selected from triethanolamine, a cationic polyethyleneimine polymer and mixtures thereof.

Polyethyleneimine compounds (PEI) are polymeric amines or polyamines, and include, polyethyleneimine compounds (PEI) and/or its derivatives. Polyethyleneimines may include primary, secondary or tertiary amine compounds. The polyethyleneimine compounds and/or its derivatives may include linear and/or branched polyethylene-imines. Still further, polyethyleneimines and/or its derivatives can vary significantly in molecular weight, topology and shape, including for example linear, branched or comb-like structures as a result of ring-opening polymerization of the ethylenimine. See Angelescu et al., Langmuir, 27, 9961-9971 (2011).

Linear polyethyleneimines are prepared by the cationic polymerization of oxazoline and oxazine derivatives. Methods for preparing linear PEI are described in Advances in Polymer Science, Vol. 102, pgs. 171-188, 1992 (references 6-31). Polyethyleneimines can also be made by the polymerization of aziridine to afford a polymeric amine often containing primary, secondary, and tertiary amine functionality.

Exemplary PEI products include multifunctional cationic polyethyleneimines with branched polymer structures according to the following formula (—(CH₂—CH₂—NH)ₙ—), with a molecular mass of 43.07 (as repeating units). In certain aspects the formula (—(CH₂—CH₂—NH)ₙ—) has a value of n that is at least 10 to 10⁵, and wherein the nitrogen to carbon ratio is 1:2. PEI polymers have the general following polymer structure:

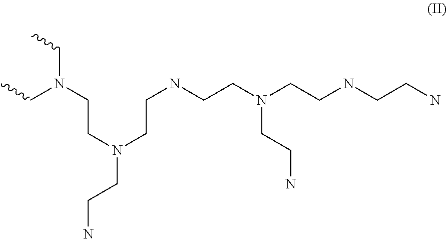

Various commercial polyethyleneimines are available, including for example those sold under the tradename Lupasol® (BASF), including for example Lupasol® FG, Lupasol® G, Lupasol® PR 8515, Lupasol® WF, Lupasol® G 20/35/100, Lupasol® HF, Lupasol® P, Lupasol® PS, Lupasol® PO 100, Lupasol® PN 50/60, and Lupasol® SK. Such exemplary polyethyleneimines are available as anhydrous polyethyleneimines and/or modified polyethyleneimines provided in aqueous solutions or methoyxypropanol (Lupasol® PO 100). The molar mass of the polyethyleneimines, including modified polyethyleneimines is in the range from 800 g/mol to 2,000,000 g/mol. In certain aspects the polymeric amine bleach activators, and preferably the PEI bleach activators, may be a branched, spherical polymeric amine.

In an embodiment of the presently claimed invention, the cationic polyethyleneimine polymer is linear, branched or hyperbranched and is represented by the formula (III)

—(CH₂—CH₂—NH)ₙ— (III)

wherein
n is an integer in between 10 to 10 000;

In yet another embodiment of the presently claimed invention, the cationic polyethyleneimine polymer has a weight average molecular weight from 200 g/mol to 2000000 g/mol.

In an embodiment of the presently claimed invention, the cationic polyethyleneimine polymer has a weight average molecular weight from 200 g/mol to 1000 g/mol.

In an embodiment of the presently claimed invention, the cationic polyethyleneimine polymer has a weight average molecular weight of 800 g/mol.

In an embodiment of the presently claimed invention, the pH-adjusting agent is selected from citric acid, sulfuric acid, acetic acid, maleic acid, potassium phosphate, and oleic acid, and mixtures thereof.

In a preferred embodiment of the presently claimed invention, the pH adjusting agent is citric acid.

In an embodiment, the pH adjusting agent is dissolved in water to obtain a solution.

In an embodiment of the presently claimed invention, the amount of citric acid solution used for pH adjustment has 10%, 20%, 30%, 40%, 50%, 60%, and 80% concentration in water.

In an embodiment of the presently claimed invention, the citric acid solution used for pH adjustment has a 50% concentration in water.

In a preferred embodiment of the presently claimed invention, the pH of the microemulsion composition is in the range of from 6.5 to 7.4, more specifically in the range of from 6.8 to 7.2, particularly in the range of from 6.9 to 7.1, when measured at 25° C.

In another embodiment of the presently claimed invention, the pH of the microemulsion composition is 6.5±0.01, 6.6±0.01, 6.7±0.01, 6.8±0.01, 6.9±0.01, 7.0±0.01, 7.1±0.01, 7.2±0.01, 7.3±0.01, 7.4±0.01, when measured at 25° C.

Additives/Auxiliary Agents:

The compositions of the presently claimed invention may further comprise at least one additive/auxiliary compound selected from anti-foaming agent thickeners, bactericides, anti-freezing agents, UV-protectants, colorants, adhesives, and mixtures thereof.

The compositions comprise anti-foaming agents. Non-limiting examples of suitable anti-foaming agents include silicone emulsions such as for example Silikon SRE from Wacker Germany or Rhodorsil from Rhodia, France; long chain alcohols; fatty acids; salts of fatty acids; organofluorine compounds and their mixtures

Suitable thickeners are polysaccharides, for e.g. xanthan gum, carboxymethyl cellulose, organic clays (organically modified or unmodified), polycarboxylates and silicates.

Suitable anti-freezing agents are ethylene glycol, diethylene glycol, propylene glycol, urea and glycerin.

Suitable bactericides are bronopol and isothiazolinone derivatives such as alkylisothiazolinones and benzisothiazolinones.

Suitable colorants include both pigments, which are sparingly soluble in water, and dyes, which are soluble in water. Non-limiting examples are Rhodamin B, C. I. Pigment Red 112 and C. I. Solvent Red 1, Pigment Blue 15:4, Pigment Blue 15:3, Pigment Blue 15:2, 35 Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown, 25, Basic Violet 10, Basic Violet 49, Acid Red 51, Acid Red 52, Acid Red 14, Acid Blue 9, Acid Yellow 23, Basic Red 10, Basic Red 108, iron oxide, titanium oxide, iron hexacyanoferrate.

Suitable adhesives are polyvinyl pyrrolidone, polyvinyl acetates, polyvinyl alcohols, polyacrylates, biological or synthetic waxes, and cellulose ethers.

In a preferred embodiment of the presently claimed invention, the amount of the auxiliary agents is in the range of from 0.1 to 10% or 0.1 to 9% or 0.1 to 8% or 0.1 to 7% or 0.1 to 6% or 0.1 to 5% or 0.1 to 4% or 0.1 to 3% or 0.1 to 2% or 0.1 to 1%, more preferably in the range of 0.1 to 2.5% or 0.1 to 2.25% or 0.1 to 1.75% or 0.1 to 1.5% or 0.1 to 1.25%, in each case based on the final weight of the composition.

The microemulsion of the presently claimed invention will usually be an oil-in-water emulsion, i.e. water forms the continuous phase, while solvent and topramezone are present in the dispersed phase.

The microemulsion compositions of the presently claimed invention provides stable formulations of topramezone.

The microemulsion compositions of the presently claimed invention are stable liquid formulations that are clear and stable upon storage.

The microemulsion compositions of the presently claimed invention are stable on dilution.

In a preferred embodiment, individual components of the compositions according to the invention may be mixed in a spray tank and further additives/auxiliary agents may be added, if appropriate.

The compositions according to the presently claimed invention can be applied from a pre-dosage device, a knapsack sprayer, a spray tank, a spray plane, or an irrigation system.

The compositions of the presently claimed invention are suitable for controlling a large number of harmful plants, including monocotyledonous weeds and dicotyledonous weeds. They are in particular useful for controlling annual weeds such as gramineous weeds (grasses) including Echinochloa species such as barnyardgrass (Echinochloa crusgali var. crusgalli), Digitaria species such as crabgrass (Digitaria sanguinalis), Setaria species such as green foxtail (Setaria vindis) and giant foxtail (Setaria faberii), Sorghum species such as johnsongrass (Sorghum halepense Pers.), Avena species such as wild oats (Avena fatua), Cenchrus species such as Cenchrus echinatus, Bromus species, Lolium species, Phalaris species, Eriochloa species, Panicum species, Brachiaria species, annual bluegrass (Poa annua), blackgrass (Alopecurus myosuroides), Aegilops cylindrica, Agropyron repens, Apera spicaventi, Eleusine indica, Cynodon dactylon and the like. The compositions of the presently claimed invention are also suitable for controlling a large number of dicotyledonous weeds, in particular broad leaf weeds including particular broadleaf weeds including Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisllfolia), Acanthospermum species, Anthemis species, Atriplex species, Cirsium species, Convolvulus species, Conyza species, such as horseweed (Conyza canadensis), Cassia species, Commelina species, Datura species, Euphorbia species, Geranium species, Galinsoga species, morningglory (Ipomoea species), Lamium species, Malva species, Matricaria species, Sysimbrium species, Solanum species, Xanthium species, Veronica species, Viola species, common chickweed (Stellaria media), velvetleaf (Abutilon theophrast), Hemp sesbania (Sesbania exaltata Cory), Anoda cristata, Bidens pllosa, Brassica kaber, Capsella bursa-pastoris, Centaurea cyanus, Galeopsis tetrahit, Galium aparine, Helianthus annuus, Desmodium tortuosum, Kochia scoparia, Mercurialis annua, Myosotis arvensis, Papaver rhoeas, Raphanus raphanistrum, Salsola kali, Sinapis arvensis, Sonchus arvensis, Thlaspi arvense, Tagetes minuta, Richardia braslliensis, and the like.

The compositions of the present invention are suitable for combating/controlling undesired vegetation in plants their environment and/or seeds. The plants include crops and non-crops.

The compositions of the presently claimed invention are suitable for combating/controlling undesired vegetation in small-grain cereal crops, such as wheat, durum, triticale, rye and barley.

The compositions of the present invention are suitable for combating/controlling undesired vegetation in non-crop areas include tufts, lawns, golf courses, or parks

If not stated otherwise, the compositions of the invention are suitable for application in any variety of the aforementioned crop plants.

The compositions according to the presently claimed invention can also be used in crop plants that have been modified by breeding, mutagenesis or genetic engineering, e.g. have been rendered tolerant to applications of specific classes of herbicides, such as auxinic herbicides such as dicamba or 2,4-D; bleacher herbicides such as 4-hydroxyphenylpyruvate dioxygenase (HPPD) inhibitors or phytoene desaturase (PDS) inhibitors; acetolactate synthase (ALS) inhibitors such as sulfonylureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase inhibitors; lipid biosynthesis inhibitors such as acetylCoA carboxylase (ACCase) inhibitors; or oxynil (i.e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxinic herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Several cultivated plants have been rendered tolerant to herbicides by mutgenesis and conventional methods of breeding, e.g., Clearfield® summer rape (Canola, BASF SE, Germany) being tolerant to imidazolinones, e.g., imazamox, or ExpressSun® sunflowers (DuPont, USA) being tolerant to sulfonyl ureas, e.g., tribenuron. Genetic engineering methods have been used to render cultivated plants such as soybean, cotton, corn, beets and rape, tolerant to herbicides such as glyphosate, imidazolinones and glufosinate, some of which are under development or commercially available under the brands or trade names Roundup Ready® (glyphosate tolerant, Monsanto, USA), Cultivance® (imidazolinone tolerant, BASF SE, Germany) and Liberty Link® (glufosinate tolerant, Bayer CropScience, Germany).

The compositions according to the presently claimed invention can also be used in genetically modified crop plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant to improve certain properties of the plant. Such genetic modifications also include but are not limited to targeted post-translational modification of protein(s), oligo- or polypeptides. e.g., by inclusion therein of amino acid mutation(s) that permit, decrease, or promote glycosylation or polymer additions such as prenylation, acetylation farnesylation, or PEG moiety attachment.

The compositions according to the presently claimed invention can also be used in crop plants that have been modified, e.g. by the use of recombinant DNA techniques to be capable of synthesizing one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, CryIIIB(b1) or Cry9c; vegetative insecticidal proteins (VIP), e.g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the presently claimed invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®, Protecta®, Bt11 (e.g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

The compositions according to presently claimed the invention can also be used in crop plants that have been modified, e.g. using recombinant DNA techniques to be capable of synthesizing one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes (e.g., potato cultivars, which express resistance genes acting against Phytophthora infestans derived from the Mexican wild potato, Solanum bulbocastanum) or T4-lysozym (e.g., potato cultivars capable of synthesizing these proteins with increased resistance against bacteria such as Erwinia amylovora). The methods for producing such genetically modified plants are generally known to the person skilled in the art and are described, e.g., in the publications mentioned above.

The compositions according to the presently claimed invention can also be used in crop plants that have been modified, e.g. using recombinant DNA techniques to be capable of synthesizing one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants.

The compositions according to the presently claimed invention can also be used in crop plants that have been modified, e.g. using recombinant DNA techniques to be capable of producing an increased amount of ingredients or new ingredients, which are suitable to improve human or animal nutrition, e.g., oil crops that produce health-promoting long-chain omega-3 fatty acids or unsaturated omega-9 fatty acids (e.g., Nexera® rape, Dow AgroSciences, Canada).

The compositions of the presently claimed invention can be applied in a conventional manner by a skilled personal familiar with the techniques of applying herbicides. Suitable techniques include spraying, atomizing, dusting, spreading or watering. The type of application depends on the intended purpose in a well-known manner, in any case, they should ensure the finest possible distribution of the active ingredients according to the invention.

The compositions can be applied pre-emergence or post-emergence, i.e. before, during and/or after emergence of the undesirable plants. When the compositions are used in crops, they can be applied after seeding and before or after the emergence of the crop plants. The compositions of the present invention could also be applied prior to seeding of the crop plants.

The compositions according to the presently claimed invention exhibit very good post-emergence herbicide activity, i.e. they show a good herbicidal activity against emerged undesirable plants. Thus, in a preferred embodiment of invention, the compositions are applied post-emergence, i.e. during and/or after, the emergence of the undesirable plants. It is particularly advantageous to apply the mixtures according to the invention post emergent when the undesirable plant starts with leaf development up to flowering. Since the compositions of the presently claimed invention show good crop tolerance, even when the crop has already emerged, they can be applied after seeding of the crop plants and in particular during or after the emergence of the crop plants.

The compositions are applied to the plants mainly by spraying, in particular foliar spraying. Application can be carried out by customary spraying techniques using, for example, water as carrier and spray liquor rates of 10 to 2000 l/ha or 50 to 1000 l/ha (for example from 100 to 500 l/ha).

In the case of a post-emergence treatment of the plants, the microemulsion compositions according to the invention are preferably applied by foliar application. Application may be affected, for example, by usual spraying techniques with water as the carrier, using amounts of spray mixture of approx. 50 to 1000 l/ha. In the method of the invention, the application rate of the composition of the presently claimed invention calculated as topramezone, is from generally from 5 to 50 g/ha and preferably from 8 to 25 g/ha.

In an embodiment, 20 to 2000 litres, preferably 50 to 400 litres, of the ready-to-use spray liquid are applied per hectare of agricultural useful area.

For use in treating crop plants, e.g. by foliar application, the rate of application of the topramezone microemulsion compositions of this invention may be in the range of 0.0001 g to 4000 g per hectare, e.g. from 1 to 2 kg per hectare or from 1 g to 750 g per hectare, desirably from 1 g to 100 g per hectare, more desirably from 10 g to 50 g per hectare, e.g., 10 to 20 g per hectare, 20 to 30 g per hectare, 30 to 40 g per hectare, or 40 to 50 g per hectare.

The microemulsion compositions of the presently claimed invention can easily be diluted with water, e.g. prior to application with large amounts of water, e.g. from 5 to 10 000 parts of water per 1 part of the formulation, in particular from 10 to 5 000 parts of water per 1 part of the formulation, without the formation of coarse material and the aqueous dilutions have enhanced physical stability, i.e. the formation of solids after dilution is not observed even after storage for a prolonged period of time, e.g. after 24 h at room temperature no crystallization is observed. The quality of water used for dilution does not play a significant role; e.g. tap water as well as well water can be used.

Upon dilution with water, the microemulsion compositions of the presently claimed invention form a bluish or even clear emulsion, indicating that the droplets/particles dispersed therein are of very small size. The average particle diameter of the droplets/particles will usually not exceed 200 nm, in particular 100 nm, more particularly 50 nm and may be 10 nm or even less than 10 nm. The small particle/size is maintained even after storage for a prolonged period of time, e.g. after storage for 24 h at room temperature the increase in particle size is generally less than 10%. The average particle size as referred herein, are Z-average particle diameters which can be determined by dynamic light scattering. Due to the small particle size after dilution with water the bioavailability and thus the biological activity of the active ingredient is often increased, in comparison with conventional formulations.

Advantages:
1. The microemulsion compositions are suitable as ready to use or ready to spray solution and thus, could be directly used.
2. Appropriate quantities of topramezone as formulated in the form of microemulsion compositions can be sprayed on crops or non-crops for effective biological action.
3. The microemulsion compositions are stable at varied temperature conditions

### EMBODIMENTS

1. A microemulsion composition comprising an oil phase and a water phase, wherein the oil phase comprises topramezone or an agriculturally acceptable salt thereof, a first solvent, a second solvent which is different from the first solvent and a first emulsifier-surfactant, and wherein the water phase comprises a stabilizer and a second emulsifier-surfactant which is different from the first emulsifier-surfactant.
2. The microemulsion composition according to embodiment 1, further defined by a dispersed phase and a continuous phase wherein the oil phase is the continuous phase and the water phase is the dispersed phase.
3. The microemulsion composition according to embodiment 1, further defined by a dispersed phase and a continuous phase wherein the oil phase is the dispersed phase and the water phase is the continuous phase.
4. The microemulsion composition according to embodiment 1, wherein the first solvent is selected from aromatic alcohols, ethers, alkyl lactates, alkyl esters of fatty acids, and mixtures thereof.
5. The microemulsion composition according to embodiment 4, wherein the first solvent has Hansen solubility parameters in the ranges of δ d 8-12 cal^{1/2} cm^{-3/2}, δ p 2-4 c cal^{1/2} cm^{-3/2} and δ h5-8 cal^{1/2} cm^{-3/2}.
6. The microemulsion composition according to any of embodiments 1 to 5, wherein the first solvent is benzyl alcohol.
7. The microemulsion composition according to embodiment 1, wherein the second solvent is selected from aromatic alcohols, ethers, alkyl lactates, alkyl esters of fatty acids, and mixtures thereof.
8. The microemulsion composition according to embodiment 7, wherein the second solvent has Hansen solubility parameters in the ranges of δ d 6-8 cal^{1/2} cm^{-3/2}, δ p1-3 cal^{1/2} cm^{-3/2}, and δ h1-3 cal^{1/2} cm^{-3/2}.
9. The composition according to any of embodiments 1 to 8, wherein the second solvent is methyl oleate.
10. The microemulsion composition according to embodiment 1, wherein the first emulsifier-surfactant is a non-ionic surfactant.
11. The microemulsion composition according to embodiment 10, wherein the first emulsifier-surfactant is selected from alkyl polyglycosides, glycerol esters of fatty acid alkoxylated alcohol, alkoxylated natural oils, glycerol esters, alkoxylated reduced sugar esters, alkoxylated glycerol monococoates, esters of polyhydric alcohol, alkoxylated amines, alkoxylated esters, alkoxylated alkyl or arylphenols, ethylene oxide/propylene oxide copolymers, and mixtures thereof.
12. The microemulsion composition according to embodiment 11, wherein the first emulsifier-surfactant is a glycerol ester of oleic acid.
13. The microemulsion composition according to embodiment 12, wherein the glycerol ester of oleic acid is glyceryl oleate.
14. The microemulsion composition according to embodiment 1, wherein the second emulsifier-surfactant is a non-ionic surfactant.
15. The microemulsion composition according to embodiment 14, wherein the second emulsifier-surfactant is selected from alkyl polyglycosides, glycerol esters of fatty acid alkoxylated alcohol, alkoxylated natural oils, glycerol esters, alkoxylated reduced sugar esters, alkoxylated glycerol monococoates, esters of polyhydric alcohol, alkoxylated amines, alkoxylated esters, alkoxylated alkyl or arylphenols, ethylene oxide/propylene oxide copolymers, and mixtures thereof.
16. The microemulsion composition according to embodiment 15, wherein the second emulsifier-surfactant is an alkyl polyglycoside.
17. The microemulsion composition according to embodiment 16, wherein the alkyl polyglycoside is represented by the formula (I)

R₁O(R₂O)_{b}(Z)ₐ (I)
wherein:
R₁ is linear or branched, unsubstituted or substituted C₄-C₃₀ alkyl or linear or branched, unsubstituted or substituted C₄-C₃₀ alkenyl;
R₂ is linear or branched, unsubstituted or substituted C₂-C₄ alkylene;
b is 0 to 100
Z is a saccharide residue having 5 to 6 carbon atoms; and
a is an integer from 1 to 6.
18. The microemulsion composition according to embodiment 17, wherein
   R₁ is linear or branched, unsubstituted C₈-C₁₆ alkyl;
   B is 0;
   Z is glucose; and
   a is an integer from 1 to 2.
19. The microemulsion composition according to embodiment 18, wherein the alkyl polyglycoside is C8-C10 alkyl polyglucoside.
20. The microemulsion composition according to embodiment 1, wherein the stabiliser is a base.
21. The microemulsion composition according to embodiment 20, wherein the base is a cationic polyethyleneimine polymer or triethanolamine.
22. The microemulsion composition according to embodiment 21, wherein the cationic polyethyleneimine polymer is linear, branched or hyperbranched and is represented by the formula (IV)

—(CH₂—CH₂—NH)ₙ (IV)
wherein
n is an integer in between 10 to 10 000; and
the weight average molecular weight (Mw) of 200 to 2 000 000 g/mol.
23. The microemulsion composition according to embodiment 22, wherein the cationic polyethyleneimine polymer has a weight average molecular weight (Mw) of 800 g/mol.
24. The microemulsion composition according to any of embodiments 1 to 23, wherein the pH of the microemulsion composition is in the range of from 6.1 to 7.4.
25. The microemulsion composition according to any of embodiments 1 to 24 which comprises a pH-adjusting agent selected from citric acid, sulfuric acid, acetic acid, maleic acid, potassium phosphate, oleic acid, and mixtures thereof.
26. The microemulsion composition according to any of embodiments 1 to 25 comprising
   0.1% to 1.0 wt. % topramezone,
   10% to 40 wt. % of the first solvent and the second solvent,
   10% to 40 wt. % of the first emulsifier-surfactant and the second emulsifier-surfactant,
   0.01% to 5 wt. % of the stabilizer, and
   1% to 99 wt % water,
   each based on the total weight of the microemulsion composition, wherein the pH of the microemulsion composition is in the range of from 6.1 to 7.4.
27. The microemulsion composition according embodiment 26, comprising:
   0.1% to 0.2 wt. % topramezone,
   25% to 30 wt. % of the first solvent and the second solvent,
   20 to 30 wt % of the first emulsifier-surfactant and the second emulsifier-surfactant,
   0.1 to 0.5 wt % of the stabilizer
   35% to 40 wt. % water,
   each based on the total weight of the microemulsion composition, wherein the pH of the microemulsion composition is in the range of from 6.1 to 7.4
28. The composition according to embodiment 27, comprising:
   0.18 wt. % topramezone,
   7.56 wt. % benzyl alcohol,
   20.05 wt. % methyl oleate,
   4.19 wt. % glyceryl mono oleate,
   28.77 wt % C8-C10 alkyl polyglucoside,
   0.44 wt % cationic polyethyleneimine polymer,
   38.79 wt % water,
   each based on the total weight of the microemulsion composition,

wherein the pH of the microemulsion composition is in the range of from 6.5 to 7.4.
29. The microemulsion composition according to embodiment 27, comprising:
   0.0088 wt. % topramezone,
   7.75 wt. % benzyl alcohol,
   20.14 wt. % methyl oleate,
   4.21 wt. % glyceryl mono oleate,
   28.89 wt % C8-C10 alkyl polyglucoside,
   0.022 wt % triethanol amine,
   38.96 wt % water,
   each based on the total weight of the microemulsion composition,

wherein the pH of the microemulsion composition is in the range of from 6.5 to 7.4.
30. A method for producing the microemulsion composition according to any of embodiments 1 to 29 comprising the steps of:
(a) dissolving the second emulsifier-surfactant and the base in water and adjusting the pH to 7 using 50% citric acid solution,
(b) stirring the solution in step (a) while maintaining the pH of the solution at 7 by adding additional citric acid solution,
(c) dissolving the topramezone in the first solvent,
(d) stirring the first emulsifier-surfactant, the second solvent, and the first solvent containing topramezone of step (c) for 15 minutes,
(e) adding the solution of step (b) to the mixture of step (d) and stirring for 5 hours to form a resultant mixture and filtering the resultant mixture to form the microemulsion composition.
31. A method of controlling undesired vegetation, comprising applying the microemulsion composition according to any of embodiments 1 to 30 to plants, their environment and/or seeds.
32. A method of controlling the undesired vegetation, comprising applying the microemulsion composition according to embodiment 28, in the form of a spray.
33. A method of controlling the undesired vegetation, comprising applying the microemulsion composition according to embodiment 29, as a ready to use solution.
34. Use of the microemulsion composition according to any of embodiments 1 to 30 for controlling the undesired vegetation.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the presently claimed invention, which are apparent to one skilled in the art.

Materials:

Compound 1: low molecular weight, highly charged cationic ethyleneimine copolymer,

Compound 2: glyceryl oleate, used as a non-ionic emulsifier and co-emulsifier in emulsion,

Compound 3: C8-C10 alkyl polyglucoside with a degree of polymerization of 1.5,

Compound 4: Methyl oleate. Methyl oleate has Hansen solubility parameters of δ d 7.1 cal^{1/2} cm^{-3/2}, δ p 1.9 cal^{1/2} cm^{-3/2}, and δ h 1.8 cal^{1/2} cm^{-3/2}, are available from BASF SE

Topramezone (purity more than 95%) is available from BASF Corporation.

Benzyl alcohol is available from Alfa Aesar. Benzyl alcohol has Hansen solubility parameters of δ d 9 cal^{1/2} cm^{-3/2}, δ p 3.1 cal^{1/2} cm^{-3/2} and δ h 6.7 cal^{1/2} cm^{-3/2}.

Triethanolamine is available from Alfa Aesar (98%).

### Example 1

Process to Make the Formulation

1. Compound 3 and compound 1 were dissolved in water and the pH was adjusted to pH 7.0 using 50% citric acid solution,

2. The solution from step (1) was stirred while maintaining the pH of the solution at pH 7.0 by adding additional citric acid solution,

3. Topramezone was dissolved in benzyl alcohol and this solution was kept aside.

4. Compound 2, compound 4 and the benzyl alcohol solution containing topramezone were mixed and stirred for 15 minutes.

5. The aqueous solution of step (2) was added to the mixture of step (4) and was stirred for 5 hours to form the microemulsion.

6. The microemulsion was filtered through Whatman #2 to obtain the final microemulsion composition.

TABLE 1

| | A | B | C |
|---|---|---|---|
| | Weight in gm | Weight in gm | Weight in gm |
| Topramezone | 2.72 | 0.1365 | 0.1365 |
| Benzyl alcohol | 117.28 | 119.86 | 119.86 |
| Compound 4 | 311.1 | 311.1 | 311.1 |
| Compound 2 | 65.1 | 65.1 | 65.1 |
| Compound 3 | 446.3 | 446.3 | 446.3 |
| Compound 1/TEA | Compound 1 | — | TEA |
| | 6.875 | | 0.35 |
| Water | 601.8 | 601.8 | 601.8 |
| Total | 1551.175 | 1544.3 | 1544.65 |

### Example 2

Microemulsion Evaluation Procedure

To evaluate the various microemulsions described below, the following test procedure was defined.

The microemulsion compositions A, B and C were evaluated for clarity and rated according to the following scale:

5=completely clear with no visible particulates or turbidity.

4=mostly clear, but with slight turbidity.

3=mostly clear, but with suspended particles.

2=slightly turbid with suspended particles.

1=very turbid with insoluble precipitate.

Stability tests by visual inspection were performed on each of the formulations A to C.

The microemulsion compositions A, B and C were stored at different temperatures, and then evaluated for clarity as shown in Table-2.

TABLE 2
Stability data

| | A | B | C | Clarity |
|---|---|---|---|---|
| | Days | Days | Days | Rating |
| Room | 98 | 210 | 210 | 5 |
| temperature | | | | |
| 40° C. | 120 | 210 | 210 | 5 |
| 50° C. | 120 | 210 | 210 | 5 |
| 2° C. | 40 | 126 | 126 | 5 |
| Freeze thaw | 7 | 7 | 7 | 5 |
| cycle (7 cycles) | | | | |

This test was used to determine the acute physical stability of the microemulsion composition. A true microemulsion remains clear for an extended period of time, however, other colloidal suspension precipitate or become turbid on setting.

Thus, it can be seen from Table 2 that the compositions were found to be clear for an extended period of time over a range of temperatures, thereby confirming that the microemulsion compositions retained their characteristics for an extended storage period.

1. A microemulsion composition comprising an oil phase and a water phase, wherein the oil phase comprises topramezone or an agriculturally acceptable salt thereof, a first solvent, a second solvent which is different from the first solvent and a first emulsifier-surfactant, and wherein the water phase comprises a stabilizer and a second emulsifier-surfactant which is different from the first emulsifier-surfactant.

2. The microemulsion composition according to claim 1, wherein the first solvent is selected from aromatic alcohols, ethers, alkyl lactates, alkyl esters of fatty acids, and mixtures thereof, and wherein the second solvent is selected from aromatic alcohols, ethers, alkyl lactates, alkyl esters of fatty acids, and mixtures thereof.

3. The microemulsion composition according to claim 2, wherein the first solvent has Hansen solubility parameters in the ranges δd 8-12 cal^{1/2} cm^{-3/2}, δp 2-4 cal^{1/2} cm^{-3/2} and δh5-8 cal^{1/2} cm^{-3/2} and, wherein the second solvent has Hansen solubility parameters in the ranges δd 6-8 cal^{1/2} cm^{-1/2}, δp1-3 cal^{1/2} cm^{-3/2}, and δh1-3 cal^{1/2} cm^{-3/2}.

4. The microemulsion composition according to claim 1, wherein the first solvent is benzyl alcohol and the second solvent is methyl oleate.

5. The microemulsion composition according to claim 1, wherein
the first emulsifier-surfactant is a non-ionic surfactant selected from alkyl polyglycosides, glycerol esters of fatty acid alkoxylated alcohol, alkoxylated natural oils, glycerol esters, alkoxylated reduced sugar esters, alkoxylated glycerol monococoates, esters of polyhydric alcohol, alkoxylated amines, alkoxylated esters, alkoxylated alkyl or arylphenols, ethylene oxide/propylene oxide copolymers, and mixtures thereof; and the second emulsifier-surfactant is a non-ionic surfactant selected from alkyl polyglycosides, glycerol esters of fatty acid alkoxylated alcohol, alkoxylated natural oils, glycerol esters, alkoxylated reduced sugar esters, alkoxylated glycerol monococoates, esters of polyhydric alcohol, alkoxylated amines, alkoxylated esters, alkoxylated alkyl or arylphenols, ethylene oxide/propylene oxide copolymers, and mixtures thereof.

6. The microemulsion composition according to claim 5, wherein the first emulsifier-surfactant is a glycerol ester of oleic acid which is glyceryl oleate.

7. The microemulsion composition according to claim 5, wherein the second emulsifier-surfactant is an alkyl polyglycoside represented by the formula (I)
R₁O(R₂O)_{b}(Z)ₐ (I)
wherein:
R₁ is linear or branched, unsubstituted or substituted C4-C30 alkyl or alkenyl;
R₂ is linear or branched, unsubstituted or substituted C2-C4 alkylene;
b is 0 to 100
Z is a saccharide residue having 5 to 6 carbon atoms; and
a is an integer from 1 to 6.

8. The microemulsion composition according to claim 7, wherein the alkyl polyglycoside is C₈-C₁₀ alkyl polyglucoside.

9. The microemulsion composition according to claim 1, wherein the stabiliser is a base selected from cationic polyethyleneimine polymer, triethanolamine and mixtures thereof.

10. The microemulsion composition according to claim 9, wherein the cationic polyethyleneimine polymer is linear, branched or hyperbranched and is represented by the formula (IV)
—(CH₂—CH₂—NH)ₙ— (IV)
wherein
n is an integer in between 10 to 10 000; and
has a weight average molecular weight (Mw) of 200 to 2 000 000 g/mol.

11. The microemulsion composition according to claim 10, wherein the cationic polyethyleneimine polymer has a weight average molecular weight (Mw) of 800 g/mol.

12. The microemulsion composition according to claim 1 further comprising a pH adjusting agent selected from citric acid, sulfuric acid, acetic acid, maleic acid, potassium phosphate, oleic acid, and mixtures thereof, to adjust the pH of the microemulsion composition in the range of from 6.1 to 7.4.

13. The microemulsion composition according to claim 1 comprising
0.1% to 1.0 wt. % topramezone,
10% to 40 wt. % of the first solvent and the second solvent,
10% to 40 wt. % of the first emulsifier-surfactant and the second emulsifier-surfactant,
0.01% to 5 wt. % of the stabilizer, and
1% to 99 wt. % water,
each based on the total weight of the microemulsion composition,
wherein the pH of the microemulsion composition is in the range of from 6.1 to 7.4.

14. A method for producing the microemulsion composition according to claim 1, the method comprising the steps of:
(a) dissolving the second emulsifier-surfactant and the base in water and adjusting the pH to 7±0.1 using 50% citric acid solution,
(b) stirring the solution in step (a) while maintaining the pH of the solution at 7±0.1 by adding additional 50% citric acid solution,
(c) dissolving the topramezone in the first solvent,
(d) stirring the first emulsifier-surfactant, the second solvent, and the first solvent containing topramezone of step (c) for 15 minutes,
(e) adding the solution of step (b) to the mixture of step (d) and stirring for 5 hours to form a resultant mixture and filtering the resultant mixture to form the microemulsion composition.

15. A method of controlling undesired vegetation,
comprising applying the microemulsion composition according to claim 1 to plants, their environment, and seeds.

16. (canceled)
